(19) United States
(12) Patent Application Publication
(10) Pub. No.: US 2016/0186042 A1
(43) Pub. Date: Jun. 30, 2016

(54) ENHANCED OIL RECOVERY PROCESS

(71) Applicant: SHELL OIL COMPANY, Houston, TX (US)

(72) Inventors: Richard Bruce TAYLOR, Sugar Land, TX (US); Stanley Nemec MILAM, Houston, TX (US); Erik Willem TEGELAAR, Rijswijk (NL); John Justin FREEMAN, Pattison, TX (US)

(21) Appl. No.: 14/977,290

(22) Filed: Dec. 21, 2015

Related U.S. Application Data
(60) Provisional application No. 62/097,277, filed on Dec. 29, 2014.

(51) Int. Cl. C09K 8/58; E21B 43/16

(52) U.S. Cl. CPC C09K 8/58; E21B 43/16

(57) ABSTRACT

A process is provided for recovering oil from a hydrocarbon-bearing formation comprised of hydrocarbons and formation water. The process presented herein includes an oil recovery formulation comprising at least 75 mol % dimethyl sulfide and between 1 mol % and 18 mol % of dimethyl ether, wherein the amount of dimethyl ether in the oil recovery formulation is selected relative to the solubility of dimethyl ether in the formation water.

This non-provisional application claims the benefit of 62/097,277 filed Dec. 29, 2014, the disclosures of which is incorporated herein by reference.

### FIELD OF THE INVENTION

The present invention is directed to a method of recovering hydrocarbons from a formation, in particular, the present invention is directed to a method of enhanced oil recovery from a hydrocarbon-bearing formation utilizing dimethyl ether and dimethyl sulfide.

### BACKGROUND OF THE INVENTION

In the recovery of oil from a subterranean hydrocarbon-bearing formation, it is possible to recover only a portion of the oil in the formation using primary recovery methods that utilize the natural formation pressure to produce the oil. A portion of the oil that cannot be produced from the formation using primary recovery methods may be produced by improved or enhanced oil recovery (EOR) methods. Improved oil recovery methods include waterflooding.

Typically, further oil is produced from the formation after primary recovery by injecting water into the formation to mobilize oil for production from the formation. The injected water may drive a portion of the oil in the formation to a well for production from the formation. Oil not produced from the formation may be trapped within pores in the formation by capillary action of water extending across the pore throats of the pores. As a result, a significant quantity of oil located in the portions of the formation may be left in the formation and not recovered by the waterflood.

Improvements to methods of recovering oil from a hydrocarbon-bearing formation having oil trapped by water within pores of the formation are desirable.

### SUMMARY OF THE INVENTION

In one aspect, the present invention is directed to a method for producing oil from a hydrocarbon-bearing formation comprised of hydrocarbons and formation water, comprising:
providing an oil recovery formulation comprising at least 75 mol % of dimethyl sulfide, and between 1 mol % and 18 mol % of dimethyl ether, wherein the amount of dimethyl ether in the oil recovery formulation is selected relative to the solubility of the dimethyl ether in the formation water;
introducing the oil recovery formulation into the hydrocarbon-bearing formation; contacting the oil recovery formulation with oil and water in the formation; and producing oil from the formation after contact of the oil recovery formulation with oil and water in the formation.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is an illustration of an oil production system in accordance with the present invention.

FIG. 2 is an illustration of an oil production system in accordance with the present invention.

FIG. 3 is an illustration of an oil production system in accordance with the present invention.

FIG. 4 is a diagram of a well pattern for production of oil in accordance with a system and process of the present invention.

FIG. 5 is a diagram of a well pattern for production of oil in accordance with a system and process of the present invention.

FIG. 6 is a graph showing oil recovery from oil sands at 30° C. using various solvents.

FIG. 7 is a graph showing oil recovery from oil sands at 10° C. using various solvents.

FIG. 8 is a graph showing the viscosity reducing effect of increasing concentrations of dimethyl sulfide on a West African Waxy crude oil.

FIG. 9 is a graph showing the viscosity reducing effect of increasing concentrations of dimethyl sulfide on a Middle Eastern Asphaltic crude oil.

FIG. 10 is a graph showing the viscosity reducing effect of increasing concentrations of dimethyl sulfide on a Canadian Asphaltic crude oil.

### DETAILED DESCRIPTION OF THE INVENTION

At least one embodiment of the present invention is directed to a method and system for enhanced oil recovery from a hydrocarbon-bearing formation comprised of hydrocarbons and formation water utilizing an oil recovery formulation comprising at least 75 mol % dimethyl sulfide, and from 1 mol % to 18 mol % dimethyl ether (hereafter dimethyl ether may be referred to as DME and dimethyl sulfide may be referred to a DMS). The oil recovery formulation is first contact miscible with liquid phase oil compositions, and, in particular, is first contact miscible with oil in the oil-bearing formation so that upon introduction into the formation the oil recovery formulation may completely mix with the oil it contacts in the formation. The oil recovery formulation may have a very low viscosity so that upon mixing with the oil it contacts in the formation a mixture of the oil and the oil recovery formulation may be produced having a significantly reduced viscosity relative to the oil initially in place in the formation. The mixture of oil and oil recovery formulation may be mobilized for movement through the formation, in part due to the reduced viscosity of the mixture relative to the oil initially in place in the formation, where the mobilized mixture may be produced from the formation, thereby producing oil from the formation.

The oil recovery formulation used in the method of the present invention is comprised of between 1 mol % to 18 mol % of dimethyl ether, and at least 75 mol % dimethyl sulfide. The dimethyl ether is present in the oil recovery formulation in an amount such that the dimethyl ether is soluble in a single phase in the water or brine at temperatures of from 0° C. to 50° C. The dimethyl ether may be present in the oil recovery formulation in an amount of from 1 mol % to 18 mol %, or from 2 mol % to 15 mol %.

The amount of dimethyl ether incorporated in the oil recovery formulation may be determined by determining the maximum amount of dimethyl ether that is soluble in formation water in a single phase, on a mole percent basis, and formulating the oil recovery formulation to include from 80-100% of dimethyl ether, on a mole percent basis, as the maximum amount of dimethyl ether that is soluble in formation water. To determine the maximum amount of dimethyl ether that is soluble in formation water, the salinity of the formation water is determined since the solubility of dimethyl ether in water is dependent on the salinity of the water. The salinity of formation water may be determined in accordance with conventional methods known to those skilled in the art of petroleum engineering. The maximum solubility of dimethyl ether in the formation water may then be determined either by 1) physically measuring the maximum solubility of dimethyl ether in the formation water wherein the dimethyl ether and water form a single phase; or 2) by plotting the maximum single phase solubility of dimethyl ether in water against known solubility curves based on the salinity of the water.

Optionally, the oil recovery formulation may be additionally comprised of fresh water having a total dissolved solids (“TDS”) content of from 100 ppm to 5000 ppm, or from 500 ppm to 2000 ppm, or at most 1000 ppm or at most 500 ppm. Preferably the fresh water has a TDS content of at least 250 ppm TDS to avoid damaging the formation by swelling clays within the formation. Alternatively, the oil recovery formulation may be comprised of brine having a TDS content of at least 10000 ppm, or from 10000 ppm to 100000 ppm, or from 15000 ppm to 50000 ppm. Preferably the brine has a TDS content of at most 50000 ppm since DME is less soluble in high salinity brines than in fresh water or low salinity brines. Most preferably, if the oil recovery formulation includes water, the water has a TDS content within 5000 ppm of the TDS content of the formation water. Most preferably, the oil recovery formulation is free of water.

The oil recovery formulation may be imbibed into a portion of the formation formed of a porous matrix of rock and water due to the presence of dimethyl ether in the oil recovery formulation. The porous matrix of rock contains oil and water therein. The water within the formation may trap oil within pores of the porous matrix by extending across the pore throat of such pores and holding oil within such pores by capillary pressure. Within the porous matrix of rock, dimethyl ether of the oil recovery formulation may mix with and pass through water at the pore throats of such pores due to the solubility of dimethyl ether with water. The dimethyl ether may then mix with oil trapped in the pores of the rock, swelling the oil and thereby releasing the oil from the pores to mobilize the oil. The dimethyl sulfide of the oil recovery formulation may mix with the oil to further mobilize the oil by reducing the viscosity thereof. The mobilized oil may then be moved through the formation to a production well for production from the formation, for example, by pushing the mobilized oil through the formation by the addition of further oil recovery formulation, or by pushing the mobilized oil through the formation to a production well by injection of water or brine into the formation, or by drawing the mobilized oil towards the production well.

Certain terms used herein are defined as follows:

“Asphaltenes”, as used herein, are defined as hydrocarbons that are insoluble in n-heptane and soluble in toluene at standard temperature and pressure.

“Miscible”, as used herein, is defined as the capacity of two or more substances, compositions, or liquids to be mixed in any ratio without separation into two or more phases.

“Fluidly operatively coupled” or “fluidly operatively connected”, as used herein, defines a connection between two or more elements in which the elements are directly or indirectly connected to allow direct or indirect fluid flow between the elements. The term “fluid flow”, as used herein, refers to the flow of a gas or a liquid.

“Oil”, as used herein, is defined as a naturally occurring mixture of hydrocarbons, generally in a liquid state, which may also include compounds of sulfur, nitrogen, oxygen, and metals.

“Residue”, as used herein, refers to oil components that have a boiling range distribution above 538° C. (1000° F.) at 0.101 MPa, as determined by ASTM Method D7169.

The oil recovery formulation provided for use in the method or system of the present invention is comprised of at least 75 mol % dimethyl sulfide. The oil recovery formulation may be comprised of at least 80 mol %, or at least 85 mol %, or at least 90 mol %, or at least 95 mol %, or at least 97 mol %, or at least 99 mol % dimethyl sulfide. The oil recovery formulation may be comprised of at least 75 vol. %, or at least 80 vol. %, or at least 85 vol %, or at least 90 vol %, or at least 95 vol. %, or at least 97 vol. %, or at least 99 vol. % dimethyl sulfide. The oil recovery formulation may be comprised of at least 75 wt. %, or at least 80 wt. %, or at least 85 wt. %, or at least 90 wt. %, or at least 95 wt. %, or at least 97 wt. %, or at least 99 wt. % dimethyl sulfide. The oil recovery formulation may consist essentially of dimethyl sulfide, or may consist of dimethyl sulfide.

The oil recovery formulation provided for use in the method or system of the present invention may be comprised of one or more co-solvents that form a mixture with the dimethyl sulfide in the oil recovery formulation. The one or more co-solvents are preferably miscible with dimethyl sulfide. The one or more co-solvents may be selected from the group consisting of o-xylene, toluene, carbon disulfide, dichloromethane, trichloromethane, C₃-C₈ aliphatic and aromatic hydrocarbons, natural gas condensates, hydrogen sulfide, diesel, kerosene, dimethyl ether, and mixtures thereof.

The oil recovery formulation provided for use in the method or system of the present invention is first contact miscible with liquid phase oil compositions, preferably any liquid phase oil composition. In liquid phase or in gas phase the oil recovery formulation may be first contact miscible with liquid phase oil compositions including heavy crude oils, intermediate crude oils, and light crude oils, and may be first contact miscible in liquid phase or in gas phase with the oil in the oil-bearing formation. The oil recovery formulation may be first contact miscible with a hydrocarbon composition, for example a liquid phase crude oil, that comprises at least 25 wt. %, or at least 30 wt. %, or at least 35 wt. %, or at least 40 wt. % hydrocarbons that have a boiling point of at least 538° C. (1000° F.) as determined by ASTM Method D7169. The oil recovery formulation may be first contact miscible with liquid phase residue and liquid phase asphaltenes in a hydrocarbonaceous composition, for example, a crude oil. The oil recovery formulation may be first contact miscible with a hydrocarbon composition that comprises less than 25 wt. %, or less than 20 wt. %, or less than 15 wt. %, or less than 10 wt. %, or less than 5 wt. % of hydrocarbons having a boiling point of at least 538° C. (1000° F.) as determined by ASTM Method D7169. The oil recovery formulation may be first contact miscible with C₃ to C₈ aliphatic and aromatic hydrocarbons containing less than 5 wt. % oxygen, less than 10 wt. % sulfur, and less than 5 wt. % nitrogen.

The oil recovery formulation may be first contact miscible with hydrocarbon compositions, for example a crude oil or liquid phase oil, over a wide range of viscosities. The oil recovery formulation may be first contact miscible with a hydrocarbon composition having a low or moderately low viscosity. The oil recovery formulation may be first contact miscible with a hydrocarbon composition, for example a liquid phase oil, having a dynamic viscosity of at most 1000 mPa s (1000 cP), or at most 500 mPa s (500 cP), or at most 100 mPa s (100 cP) at 25° C. The oil recovery formulation may also be first contact miscible with a hydrocarbon composition having a moderately high or a high viscosity. The oil recovery formulation may be first contact miscible with a hydrocarbon composition, for example a liquid phase oil, having a dynamic viscosity of at least 1000 mPa s (1000 cP), or at least 5000 mPa s (5000 cP), or at least 10000 mPa s (10000 cP), or at least 50000 mPa s (50000 cP), or at least 100000 mPa s (100000 cP), or at least 500000 mPa s (500000 cP) at 25° C. The oil recovery formulation may be first contact miscible with hydrocarbon composition, for example a liquid phase oil, having a dynamic viscosity of from 1 mPa s (1 cP) to 5000000 mPa s (5000000 cP), or from 100 mPa s (100 cP) to 1000000 mPa s (1000000 cP), or from 500 mPa s (500 cP) to 500000 mPa s (500000 cP), or from 1000 mPa s (1000 cP) to 100000 mPa s (100000 cP) at 25° C.

The oil recovery formulation provided for use in the method or system of the present invention preferably has a low viscosity. The oil recovery formulation may be a fluid having a dynamic viscosity of at most 0.35 mPa s (0.35 cP), or at most 0.3 mPa s (0.3 cP), or at most 0.285 mPa s (0.285 cP) at a temperature of 25° C.

The oil recovery formulation provided for use in the method or system of the present invention preferably has a relatively low density. The oil recovery formulation may have a density of at most 0.9 g/cm³, or at most 0.85 g/cm³.

The oil recovery formulation provided for use in the method or system of the present invention may have a relatively high cohesive energy density. The oil recovery formulation provided for use in the method or system of the present invention may have a cohesive energy density of from 300 Pa to 410 Pa, or from 320 Pa to 400 Pa.

The oil recovery formulation provided for use in the method or system of the present invention preferably is relatively non-toxic or is non-toxic. The oil recovery formulation may have an aquatic toxicity of LC₅₀ (rainbow trout) greater than 200 mg/l at 96 hours. The oil recovery formulation may have an acute oral toxicity of LD₅₀ (mouse and rat) of from 535 mg/kg to 3700 mg/kg, an acute dermal toxicity of LD₅₀ (rabbit) of greater 5000 mg/kg, and an acute inhalation toxicity of LC₅₀ (rat) of 40250 ppm at 4 hours.

In the method of the present invention the oil recovery formulation is introduced into a oil-bearing formation, and the system of the present invention includes a oil-bearing formation. The oil-bearing formation comprises oil that may be separated and produced from the formation after contact and mixing with the oil recovery formulation. The oil of the oil-bearing formation is first contact miscible with the oil recovery formulation. The oil of the oil-bearing formation may be a heavy oil containing at least 25 wt. %, or at least 30 wt. %, or at least 35 wt. %, or at least 40 wt. % of hydrocarbons having a boiling point of at least 538° C. (1000° F.) as determined in accordance with ASTM Method D7169. The heavy oil may contain at least 20 wt. % residue, or at least 25 wt. % residue, or at least 30 wt. % residue. The heavy oil may have an asphaltene content of at least at least 5 wt. %, or at least 10 wt. %, or at least 15 wt. %.

The oil contained in the oil-bearing formation may be an intermediate weight oil or a relatively light oil containing less than 25 wt. %, or less than 20 wt. %, or less than 15 wt. %, or less than 10 wt. %, or less than 5 wt. % of hydrocarbons having a boiling point of at least 538° C. (1000° F.). The intermediate weight oil or light oil may have an asphaltenes content of less than 5 wt. %.

The oil contained in the oil-bearing formation may have a viscosity under formation conditions (in particular, at temperatures within the temperature range of the formation) of at least 1 mPa s (1 cP), or at least 10 mPa s (10 cP), or at least 100 mPa s (100 cP), or at least 1000 mPa s (1000 cP), or at least 10000 mPa s (10000 cP). The oil contained in the oil-bearing formation may have a viscosity under formation temperature conditions of from 1 to 10000000 mPa s (1 to 10000000 cP). In an embodiment, the oil contained in the oil-bearing formation may have a viscosity under formation temperature conditions of at least 1000 mPa s (1000 cP), where the viscosity of the oil is at least partially, or solely, responsible for immobilizing the oil in the formation.

The oil contained in the oil-bearing formation may contain little or no microcrystalline wax at formation temperature conditions. Microcrystalline wax is a solid that may be only partially soluble, or may be substantially insoluble, in the oil recovery formulation. The oil contained in the oil-bearing formation may comprise at most 3 wt. %, or at most 1 wt. %, or at most 0.5 wt. % microcrystalline wax at formation temperature conditions, and preferably microcrystalline wax is absent from the oil in the oil-bearing formation at formation temperature conditions.

The oil-bearing formation may be a subterranean formation. The subterranean formation may be comprised of one or more porous matrix materials selected from the group consisting of a porous mineral matrix, a porous rock matrix, and a combination of a porous mineral matrix and a porous rock matrix, where the porous matrix material may be located beneath an overburden at a depth ranging from 50 meters to 6000 meters, or from 100 meters to 4000 meters, or from 200 meters to 2000 meters under the earth's surface. The subterranean formation may be a subsea subterreanan formation.

The porous matrix material may be a consolidated matrix material in which at least a majority, and preferably substantially all, of the rock and/or mineral that forms the matrix material is consolidated such that the rock and/or mineral forms a mass in which substantially all of the rock and/or mineral is immobile when oil, the oil recovery formulation, water, or other fluid is passed therethrough. Preferably at least 95 wt. % or at least 97 wt. %, or at least 99 wt. % of the rock and/or mineral is immobile when oil, the oil recovery formulation, water, or other fluid is passed therethrough so that any amount of rock or mineral material dislodged by the passage of the oil, oil recovery formulation, water, or other fluid is insufficient to render the formation impermeable to the flow of the oil recovery formulation, oil, water, or other fluid through the formation. The porous matrix material may be an unconsolidated matrix material in which at least a majority, or substantially all, of the rock and/or mineral that forms the matrix material is unconsolidated. The formation may have a permeability of from 0.000001 to 15 Darcies, or from 0.001 to 1 Darcy. The rock and/or mineral porous matrix material of the formation may be comprised of sandstone and/or a carbonate selected from dolomite, limestone, and mixtures thereof—where the limestone may be microcrystalline or crystalline limestone and/or chalk.

Oil in the oil-bearing formation may be located in pores within the porous matrix material of the formation. The oil in the oil-bearing formation may be immobilized in the pores within the porous matrix material of the formation, for example, by capillary forces, by interaction of the oil with the pore surfaces, by the viscosity of the oil, or by interfacial tension between the oil and water in the formation.

The oil-bearing formation may also be comprised of water, which may be located in pores within the porous matrix material. The water in the formation may be connate water, water from a secondary or tertiary oil recovery process water-flood, or a mixture thereof. The water in the oil-bearing formation may be positioned to immobilize oil within the pores. Contact of the oil recovery formulation with the oil in the formation may mobilize the oil in the formation for production and recovery from the formation by freeing at least a portion of the oil from pores within the formation.

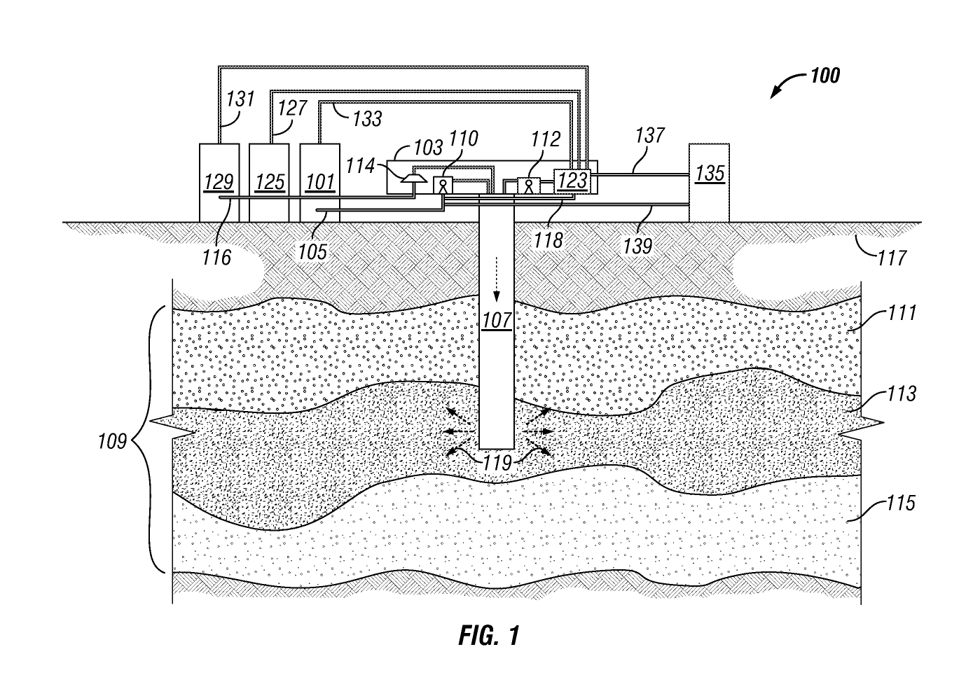

Referring now to FIG. 1, a system 100 of the present invention is shown for practicing a method of the present invention. An oil recovery formulation as described above may be provided in an oil recovery formulation storage facility 101 fluidly operatively coupled to an injection/production facility 103 via conduit 105. Injection/production facility 103 may be fluidly operatively coupled to a well 107, which may be located extending from the injection/production facility 103 into a oil-bearing formation 109 such as described above comprised of one or more formation portions 111, 113, and 115 formed of porous material matricies, such as described above, located beneath an overburden 117. As shown by the down arrow in well 107, the oil recovery formulation may flow from the injection/production facility 103 through the well to be introduced into the formation 109, for example in formation portion 113, where the injection/production facility 103 and the well 107, or the well 107 itself, include(s) a mechanism for introducing the oil recovery formulation into the formation 109. The mechanism for introducing the oil recovery formulation into the formation 109 may be comprised of a pump 110 for delivering the oil recovery formulation to perforations or openings in the well through which the oil recovery formulation may be injected into the formation.

The oil recovery formulation is introduced into the formation 109, for example by being injected into the formation by pumping the oil recovery formulation into the formation. The oil recovery formulation may be introduced into the formation at a pressure above the instantaneous pressure in the formation to force the oil recovery formulation to flow into the formation. The pressure at which the oil recovery formulation is introduced into the formation may range from the instantaneous pressure in the formation up to, but not including, the fracture pressure of the formation. The pressure at which the oil recovery formulation may be injected into the formation may range from 20% to 95%, or from 40% to 90%, of the fracture pressure of the formation. The pressure at which the oil recovery formulation is injected into the formation may range from a pressure from greater than 0 MPa to 37 MPa above the initial formation pressure as measured prior to when the injection begins.

An amount of the oil recovery formulation may be introduced into the formation to form a mobilized mixture of oil and the oil recovery formulation. The amount of oil recovery formulation introduced into the formation may be sufficient to form a mobilized mixture of the oil recovery formulation and oil that may contain at least 10 vol. %, or at least 20 vol. %, or at least 30 vol. %, or at least 40 vol. %, or at least 50 vol. %, or greater than 50 vol. % of the oil recovery formulation.

As the oil recovery formulation is introduced into the formation 109, the oil recovery formulation spreads into the formation as shown by arrows 119. Upon introduction to the formation 109, the oil recovery formulation contacts and forms a mixture with a portion of the oil in the formation. The oil recovery formulation is first contact miscible with the oil in the formation, where the oil recovery formulation mobilizes at least a portion of the oil in the formation upon mixing with the oil. The oil recovery formulation may mobilize the oil in the formation upon mixing with the oil, for example, by reducing the viscosity of the mixture relative to the native oil in the formation, by reducing the capillary forces retaining the oil in pores in the formation, by reducing the wettability of the oil on pore surfaces in the formation, by reducing the interfacial tension between oil and water in the pores in the formation, and/or by swelling the oil in the pores in the formation.

The respective viscosities of the oil recovery formulation and water in the formation may be on the same order of magnitude, thereby providing for a favorable displacement of the water from pores of the formation by the oil recovery formulation and corresponding ingress of the oil recovery formulation into the pores of the formation for mixing with oil contained in the pores. For example, the viscosity of the oil recovery formulation may range between about 0.2 cP and about 0.35 cP under formation temperature conditions. The viscosity of water of the formation may range between about 0.7 cP and about 1.1 cP under formation temperature conditions. As a result, the oil recovery formulation is able to push the water out of the way and simultaneously contact, mix, and mobilize the oil.

The oil recovery formulation may be left to soak in the formation after introduction of the oil recovery formulation into the formation to mix with and mobilize the oil in the formation. The oil recovery formulation may be left to soak in the formation for a period of time from 1 hour to 15 days, preferably from 5 hours to 50 hours.

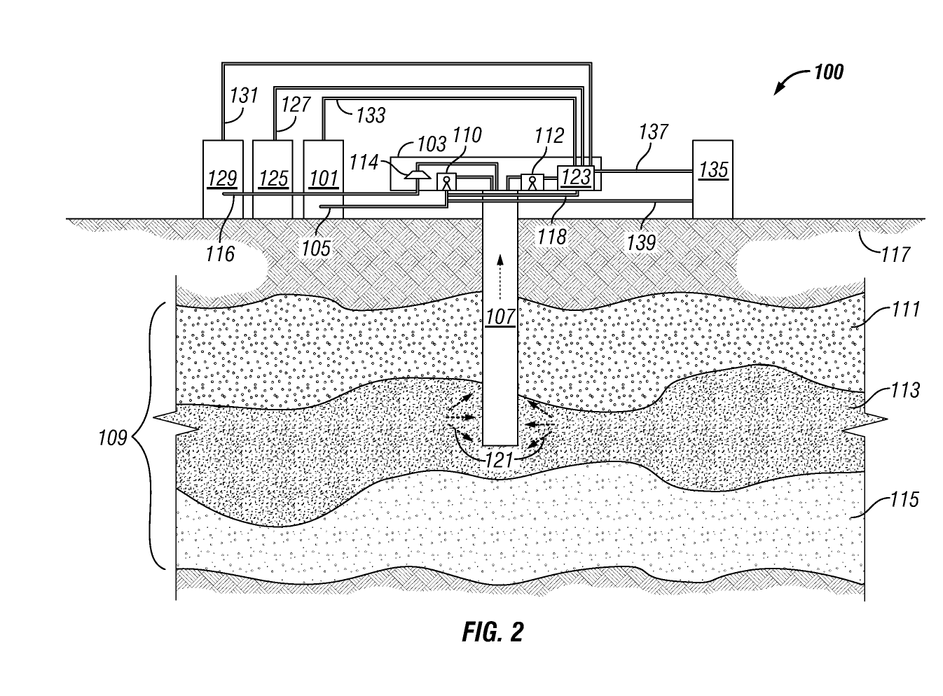

Subsequent to the introduction of the oil recovery formulation into the formation 109 and after the soaking period, oil may be recovered and produced from the formation 109, as shown in FIG. 2. Optionally oil recovery formulation—preferably in a mixture with the oil—is also recovered and produced from the formation 109, and optionally gas and water from the formation are also recovered and produced from the formation 109. The system includes a mechanism for producing the oil, and may include a mechanism for producing the oil recovery formulation, gas, and water from the formation 109 subsequent to introduction of the oil recovery formulation into the formation, for example, after completion of introduction of the oil recovery formulation into the formation. The mechanism for recovering and producing the oil, and optionally the oil recovery formulation, gas and water from the formation 109 may be comprised of a pump 112, which may be located in the injection/production facility 103 and/or within the well 107, and which draws the oil, and optionally the oil recovery formulation, gas, and water from the formation to deliver the oil, and optionally the oil recovery formulation, gas, and water to the facility 103.

Alternatively, the mechanism for recovering and producing the oil and the oil recovery formulation, and optionally gas and water, from the formation 109 may be comprised of a compressor 114. The compressor 114 may be fluidly operatively coupled to a gas storage tank 129 by conduit 116, and may compress gas from the gas storage tank for injection into the formation 109 through the well 107. The compressor 114 may compress gas from a gas storage tank for injection into the formation 109 through the well 107. The compressor may compress the gas to a pressure sufficient to drive production of oil and the oil recovery formulation, and optionally gas and water, from the formation via the well 107, where the appropriate pressure can be determined by conventional methods known to those skilled in the art. The compressed gas may be injected into the formation from a different position on the well 107 than the well position at which the oil and optionally the oil recovery formulation, water and/or gas, are produced from the formation, for example, the compressed gas may be injected into the formation at formation portion 111 while oil, oil recovery formulation, water, and gas are produced from the formation at formation portion 113.

Oil, preferably in a mixture with the oil recovery formulation, and optionally mixed with water and formation gas may be drawn from the formation portion 113 as shown by arrows 121 and produced back up the well 107 to the injection/production facility 103. The oil may be separated from the oil recovery formulation, water, and gas in a separation unit 123. The separation unit may be comprised of a conventional liquid-gas separator for separating gas from the oil, oil recovery formulation, and water, a conventional hydrocarbon-water separator for separating water from oil and the oil recovery formulation, and a conventional distillation column for separating the oil recovery formulation from the oil. For ease of separation of the produced oil recovery formulation from the produced oil, the produced oil recovery formulation may be separated from the oil by distillation so that the produced oil recovery formulation contains C₃ to C₈, or C₃ to C₆, aliphatic and aromatic hydrocarbons originating from the oil produced from the formation and not present in the initial oil recovery formulation. The distillation may be effected so the produced oil recovery formulation has the composition of the original oil recovery formulation plus up to 25 vol. % of C₃ to C₈ aliphatic and aromatic hydrocarbons derived from the formation, where the separated produced oil recovery formulation is comprised of at least 75 mol % dimethyl sulfide.

The separated oil may be provided from the separation unit 123 of the injection/production facility 103 to a liquid storage tank 125, which may be fluidly operatively coupled to the separation unit of the injection/production facility by conduit 127. The separated gas may be provided from the separation unit 123 of the injection/production facility 103 to the gas storage tank 129, which may be fluidly operatively coupled to the separation unit of the injection/production facility by conduit 131.

The separated produced oil recovery formulation, optionally containing additional C₃ to C₈ or C₃ to C₆ hydrocarbons, may be provided from the separation unit 123 of the injection/production facility to the oil recovery formulation storage facility 101, which may be fluidly operatively coupled to the separation unit of the injection/production facility by conduit 133. Alternatively, the separated produced oil recovery formulation, optionally containing additional C₃ to C₈ or C₃ to C₆ hydrocarbons, may be provided from the separation unit 123 of the injection/production facility 103 to the injection mechanism 110 for reinjection into the formation 109, where the separation unit 123 may be fluidly operatively coupled to the injection mechanism 110 via conduit 118 to provide the separated produced oil recovery formulation from the separation unit 123 to the injection mechanism 110.

Separated water may be provided from the separation unit 123 of the injection/production facility 103 to a water tank 135, which may be fluidly operatively coupled to the separation unit of the injection/production facility by conduit 137. The water tank 135 may be fluidly operatively coupled to the injection mechanism 110 by conduit 139 for re-injection of water produced from the formation back into the formation.

After recovery and production of at least a portion of the oil from the formation 109, and optionally recovering and producing at least a portion of the oil recovery formulation injected into the formation, an additional portion of the oil recovery formulation may be injected into the formation to mobilize at least a portion of the oil remaining in the formation for recovery and production. The amount of the additional portion of oil recovery formulation injected into the formation 109 may be increased relative to the amount of oil recovery formulation injected prior to the injection of the additional portion of oil recovery formulation to increase the pore volume of the formation that is contacted by the oil recovery formulation. An additional portion of the oil remaining in the formation may be mobilized, recovered and produced from the well subsequent to injection of the additional portion of the oil recovery formulation in a manner as described above. Subsequent additional portions of oil recovery formulation may be injected into the formation for further recovery and production of oil from the formation 109, as desired.

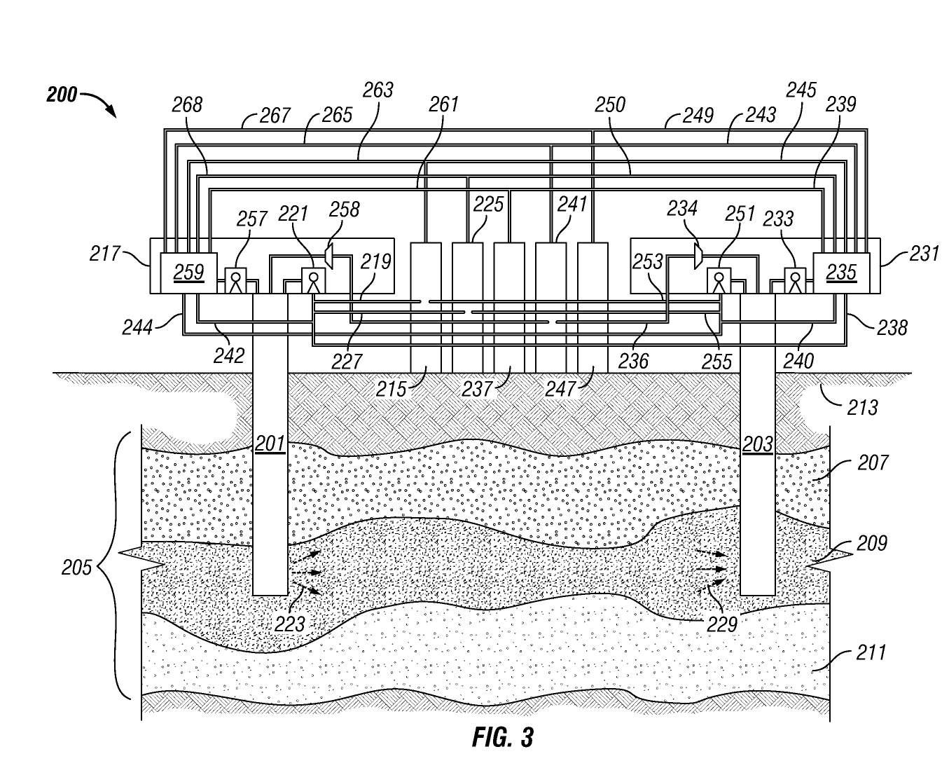

Referring now to FIG. 3, a system 200 of the present invention for practicing a method of the present invention is shown. The system includes a first well 201 and a second well 203 extending into a oil-bearing formation 205 such as described above. The oil-bearing formation 205 may be comprised of one or more formation portions 207, 209, and 211 formed of porous material matrices, such as described above, located beneath an overburden 213. An oil recovery formulation as described above is provided. The oil recovery formulation may be provided from an oil recovery formulation storage facility 215 fluidly operatively coupled to a first injection/production facility 217 via conduit 219. First injection/production facility 217 may be fluidly operatively coupled to the first well 201, which may be located extending from the first injection/production facility 217 into the oil-bearing formation 205. The oil recovery formulation may flow from the first injection/production facility 217 through the first well to be introduced into the formation 205, for example in formation portion 209, where the first injection/production facility 217 and the first well, or the first well itself, include(s) a mechanism for introducing the oil recovery formulation into the formation. Alternatively, the oil recovery formulation may flow from the oil recovery formulation storage facility 215 directly to the first well 201 for injection into the formation 205, where the first well comprises a mechanism for introducing the oil recovery formulation into the formation. The mechanism for introducing the oil recovery formulation into the formation 205 via the first well 201—located in the first injection/production facility 217, the first well 201, or both—may be comprised of a pump 221 for delivering the oil recovery formulation to perforations or openings in the first well through which the oil recovery formulation may be introduced into the formation.

The oil recovery formulation may be introduced into the formation 205, for example by injecting the oil recovery formulation into the formation through the first well 201 by pumping the oil recovery formulation through the first well and into the formation. The pressure at which the oil recovery formulation may be injected into the formation 205 through the first well 201 may be as described above with respect to injection and production using a single well.

The volume of oil recovery formulation introduced into the formation 205 via the first well 201 may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the oil recovery formulation between the first well 201 and the second well 203. The pore volume may be readily be determined by methods known to a person skilled in the art, for example by modelling studies or by injecting water having a tracer contained therein through the formation 205 from the first well 201 to the second well 203.

As the oil recovery formulation is introduced into the formation 205, the oil recovery formulation spreads into the formation as shown by arrows 223. Upon introduction to the formation 205, the oil recovery formulation contacts and forms a mixture with a portion of the oil in the formation. The oil recovery formulation is first contact miscible with the oil in the formation 205, where the oil recovery formulation may mobilize the oil in the formation upon contacting and mixing with the oil. The oil recovery formulation may mobilize the oil in the formation upon contacting and mixing with the oil, for example, by reducing the viscosity of the mixture relative to the native oil in the formation, by reducing the capillary forces retaining the oil in pores in the formation, by reducing the wettability of the oil on pore surfaces in the formation, by reducing the interfacial tension between oil and water in the pores in the formation, and/or by swelling the oil in the pores in the formation. As noted above, the oil recovery formulation may have a viscosity on the same order of magnitude as the viscosity of water in the formation at formation temperature conditions enabling the oil recovery formation to displace water from pores of the formation to penetrate the pores and contact, mix with, and mobilize oil contained therein.

The mobilized mixture of the oil recovery formulation and oil and any unmixed oil recovery formulation may be pushed across the formation 205 from the first well 201 to the second well 203 by further introduction of more oil recovery formulation or by introduction of an oil immiscible formulation into the formation subsequent to introduction of the oil recovery formulation into the formation. The oil immiscible formulation may be introduced into the formation 205 through the first well 201 after completion of introduction of the oil recovery formulation into the formation to force or otherwise displace the mobilized mixture of the oil recovery formulation and oil as well as any unmixed oil recovery formulation toward the second well 203 for production. Any unmixed oil recovery formulation may mix with and mobilize more oil in the formation 205 as the unmixed oil recovery formulation is displaced through the formation from the first well 201 towards the second well 203.

The oil immiscible formulation may be configured to displace the mobilized mixture of oil recovery formulation and oil as well as any unmixed oil recovery formulation through the formation 205. Suitable oil immiscible formulations are not first contact miscible or multiple contact miscible with oil in the formation 205. The oil immiscible formulation may be selected from the group consisting of an aqueous polymer fluid, water in gas or liquid form, carbon dioxide at a pressure below its minimum miscibility pressure, nitrogen at a pressure below its minimum miscibility pressure, air, and mixtures of two or more of the preceding.

Suitable polymers for use in an aqueous polymer fluid may include, but are not limited to, polyacrylamides, partially hydrolyzed polyacrylamides, polyacrylates, ethylenic copolymers, biopolymers, carboxymethylcellulose, polyvinyl alcohols, polystyrene sulfonates, polyvinylpyrolidones, AMPS (2-acrylamide-2-methyl propane sulfonate), combinations thereof, or the like. Examples of ethylenic copolymers include copolymers of acrylic acid and acrylamide, acrylic acid and lauryl acrylate, lauryl acrylate and acrylamide. Examples of biopolymers include xanthan gum, guar gum, alginic acids, and alginate salts. In some embodiments, polymers may be crosslinked in situ in the formation 205. In other embodiments, polymers may be generated in situ in the formation 205.

The oil immiscible formulation may be stored in, and provided for introduction into the formation 205 from, an oil immiscible formulation storage facility 225 that may be fluidly operatively coupled to the first injection/production facility 217 via conduit 227. The first injection/production facility 217 may be fluidly operatively coupled to the first well 201 to provide the oil immiscible formulation to the first well for introduction into the formation 205. Alternatively, the oil immiscible formulation storage facility 225 may be fluidly operatively coupled to the first well 201 directly to provide the oil immiscible formulation to the first well for introduction into the formation 205. The first injection/production facility 217 and the first well 201, or the first well itself, may comprise a mechanism for introducing the oil immiscible formulation into the formation 205 via the first well 201. The mechanism for introducing the oil immiscible formulation into the formation 205 via the first well 201 may be comprised of a pump or a compressor for delivering the oil immiscible formulation to perforations or openings in the first well through which the oil immiscible formulation may be injected into the formation. The mechanism for introducing the oil immiscible formulation into the formation 205 via the first well 201 may be the pump 221 utilized to inject the oil recovery formulation into the formation via the first well 201.

The oil immiscible formulation may be introduced into the formation 205, for example, by injecting the oil immiscible formulation into the formation through the first well 201 by pumping the oil immiscible formulation through the first well and into the formation. The pressure at which the oil immiscible formulation may be injected into the formation 205 through the first well 201 may be up to, but not including, the fracture pressure of the formation, or from 20% to 99%, or from 30% to 95%, or from 40% to 90% of the fracture pressure of the formation. In an embodiment of the present invention, the oil immiscible formulation may be injected into the formation 205 at a pressure from greater than 0 MPa to 37 MPa above the formation pressure as measured prior to injection of the oil immiscible formulation.

The amount of oil immiscible formulation introduced into the formation 205 via the first well 201 following introduction of the oil recovery formulation into the formation via the first well may range from 0.001 to 5 pore volumes, or from 0.01 to 2 pore volumes, or from 0.1 to 1 pore volumes, or from 0.2 to 0.6 pore volumes, where the term “pore volume” refers to the volume of the formation that may be swept by the oil immiscible formulation between the first well and the second well. The amount of oil immiscible formulation introduced into the formation 205 should be sufficient to drive the mobilized oil/oil recovery formulation mixture and any unmixed oil recovery formulation across at least a portion of the formation. If the oil immiscible formulation is in liquid phase, the volume of oil immiscible formulation introduced into the formation 205 following introduction of the oil recovery formulation into the formation relative to the volume of oil recovery formulation introduced into the formation immediately preceding introduction of the oil immiscible formulation may range from 0.1:1 to 10:1 of oil immiscible formulation to oil recovery formulation, more preferably from 1:1 to 5:1 of oil immiscible formulation to oil recovery formulation. If the oil immiscible formulation is in gaseous phase, the volume of oil immiscible formulation introduced into the formation 205 following introduction of the oil recovery formulation into the formation relative to the volume of oil recovery formulation introduced into the formation immediately preceding introduction of the oil immiscible formulation may be substantially greater than a liquid phase oil immiscible formulation, for example, at least 10 or at least 20, or at least 50 volumes of gaseous phase oil immiscible formulation per volume of oil recovery formulation introduced immediately preceding introduction of the gaseous phase oil immiscible formulation.

If the oil immiscible formulation is in liquid phase, the oil immiscible formulation may have a viscosity of at least the same magnitude as the viscosity of the mobilized oil/oil recovery formulation mixture at formation temperature conditions to enable the oil immiscible formulation to drive the mixture of mobilized oil/oil recovery formulation across the formation 205 to the second well 203. The oil immiscible formulation may have a viscosity of at least 0.8 mPa s (0.8 cP) or at least 10 mPa s (10 cP), or at least 50 mPa s (50 cP), or at least 100 mPa s (100 cP), or at least 500 mPa s (500 cP), or at least 1000 mPa s (1000 cP) at formation temperature conditions or at 25° C. If the oil immiscible formulation is in liquid phase, preferably the oil immiscible formulation has a viscosity at least one order of magnitude greater than the viscosity of the mobilized oil/oil recovery formulation mixture at formation temperature conditions so the oil immiscible formulation may drive the mobilized oil/oil recovery formulation mixture across the formation in plug flow, minimizing and inhibiting fingering of the mobilized oil/oil recovery formulation mixture through the driving plug of oil immiscible formulation.

The oil recovery formulation and the oil immiscible formulation may be introduced into the formation through the first well 201 in alternating slugs. For example, the oil recovery formulation may be introduced into the formation 205 through the first well 201 for a first time period, after which the oil immiscible formulation may be introduced into the formation through the first well for a second time period subsequent to the first time period, after which the oil recovery formulation may be introduced into the formation through the first well for a third time period subsequent to the second time period, after which the oil immiscible formulation may be introduced into the formation through the first well for a fourth time period subsequent to the third time period. As many alternating slugs of the oil recovery formulation and the oil immiscible formulation may be introduced into the formation through the first well as desired.

Oil may be mobilized for production from the formation 205 via the second well 203 by introduction of the oil recovery formulation, and optionally the oil immiscible formulation, into the formation, where the mobilized oil is driven through the formation for production from the second well as indicated by arrows 229 by introduction of the oil recovery formulation, and optionally the oil immiscible formulation, into the formation via the first well 201. The oil mobilized for production from the formation 205 may include the mobilized oil/oil recovery formulation mixture. Water and/or gas may also be mobilized for production from the formation 205 via the second well 203 by introduction of the oil recovery formulation into the formation via the first well 201.

After introduction of the oil recovery formulation into the formation 205 via the first well 201, oil may be recovered and produced from the formation via the second well 203. The system may include a mechanism located at the second well for recovering and producing the oil from the formation 205 subsequent to introduction of the oil recovery formulation into the formation, and may include a mechanism located at the second well for recovering and producing the oil recovery formulation, the oil immiscible formulation, water, and/or gas from the formation subsequent to introduction of the oil recovery formulation into the formation. The mechanism located at the second well 203 for recovering and producing the oil, and optionally for recovering and producing the oil recovery formulation, the oil immiscible formulation, water, and/or gas may be comprised of a pump 233, which may be located in the second injection/production facility 231 and/or within the second well 203. The pump 233 may draw the oil, and optionally the oil recovery formulation, the oil immiscible formulation, water, and/or gas from the formation 205 through perforations in the second well 203 to deliver the oil, and optionally the oil recovery formulation, the oil immiscible formulation, water, and/or gas, to the second injection/production facility 231.

Alternatively, the mechanism for recovering and producing the oil—and optionally the oil recovery formulation, the oil immiscible formulation, gas, and water—from the formation 205 may be comprised of a compressor 234 that may be located in the second injection/production facility 231. The compressor 234 may be fluidly operatively coupled to the gas storage tank 241 via conduit 236, and may compress gas from the gas storage tank for injection into the formation 205 through the second well 203. The compressor may compress the gas to a pressure sufficient to drive production of oil—and optionally the oil recovery formulation, the oil immiscible formulation, gas, and water—from the formation via the second well 203, where the appropriate pressure may be determined by conventional methods known to those skilled in the art. The compressed gas may be injected into the formation from a different position on the second well 203 than the well position at which the oil—and optionally the oil recovery formulation, the oil immiscible formulation, water, and gas—are produced from the formation, for example, the compressed gas may be injected into the formation at formation portion 207 while oil, oil recovery formulation, oil immiscible formulation, water, and gas are produced from the formation at formation portion 209.

Oil, optionally in a mixture with the oil recovery formulation, oil immiscible formulation, water, and/or gas may be drawn from the formation 205 as shown by arrows 229 and produced up the second well 203 to the second injection/production facility 231. The oil may be separated from the oil recovery formulation, oil immiscible formulation (if any), gas, and/or water in a separation unit 235 located in the second injection/production facility 231 and fluidly coupled to the mechanism 233 for recovering and producing oil and optionally the oil recovery formulation, the oil immiscible formulation, gas, and/or water from the formation. The separation unit 235 may be comprised of a conventional liquid-gas separator for separating gas from the oil, oil recovery formulation, liquid oil immiscible formulation (if any), and water; a conventional hydrocarbon-water separator for separating the oil and oil recovery formulation from water and optionally from liquid oil immiscible formulation; a conventional distillation column for separating the oil recovery formulation—optionally in combination with C₃ to C₈, or C₃ to C₆, aliphatic and aromatic hydrocarbons derived from the formation as discussed above—from the oil; and, optionally a separator for separating liquid oil immiscible formulation from water.

The separated produced oil may be provided from the separation unit 235 of the second injection/production facility 231 to a liquid storage tank 237, which may be fluidly operatively coupled to the separation unit 235 of the second injection/production facility by conduit 239. The separated gas, if any, may be provided from the separation unit 235 of the second injection/production facility 231 to a gas storage tank 241, which may be fluidly operatively coupled to the separation unit 235 of the second injection/production facility 231 by conduit 243. Separated water may be provided from the separation unit 235 of the second injection/production facility 231 to a water tank 247, which may be fluidly operatively coupled to the separation unit 235 of the second injection/production facility 231 by conduit 249. Separated oil immiscible formulation, if any, may be provided from the separation unit 235 of the second injection/production facility 231 to the oil immiscible formulation storage facility 225 by conduit 250.

The separated produced oil recovery formulation, optionally containing additional C₃ to C₈ or C₃ to C₆ hydrocarbons, may be provided from the separation unit 235 of the second injection/production facility 231 to the oil recovery formulation storage unit 215, which may be fluidly operatively coupled to the separation unit 235 of the second injection/production facility 231 by conduit 245, where the produced oil recovery formulation may be mixed with the oil recovery formulation. Alternatively, the separated oil recovery formulation may be provided from the separation unit 235 of the second injection/production facility 231 to the injection mechanism 221 via conduit 238 for re-injection into the formation 205 through the first well 201 for further mobilization and production of oil from the formation. Alternatively, the separated oil recovery formulation may be provided from the separation unit 235 to an injection mechanism such as pump 251 in the second injection/production facility 231 via conduit 240 for re-injection into the formation 205 through the second well 203, optionally together with fresh oil recovery formulation.

In an embodiment of a system and a method of the present invention, the first well 201 may be used for injecting the oil recovery formulation into the formation 205 and the second well 203 may be used to produce oil from the formation as described above for a first time period, and the second well 203 may be used for injecting the oil recovery formulation into the formation 205 to mobilize the oil in the formation and drive the mobilized oil across the formation to the first well and the first well 201 may be used to produce oil from the formation for a second time period, where the second time period is subsequent to the first time period. The second injection/production facility 231 may comprise a mechanism such as pump 251 that is fluidly operatively coupled the oil recovery formulation storage facility 215 by conduit 253, and optionally fluidly operatively coupled to the separation units 235 and 259 by conduits 240 and 242, respectively, to receive produced oil recovery formulation therefrom, and that is fluidly operatively coupled to the second well 203 to introduce the oil recovery formulation into the formation 205 via the second well. The pump 251 or a compressor may also be fluidly operatively coupled to the oil immiscible formulation storage facility 225 by conduit 255 to introduce the oil immiscible formulation into the formation 205 via the second well 203 subsequent to introduction of the oil recovery formulation into the formation via the second well. The first injection/production facility 217 may comprise a mechanism such as pump 257 or compressor 258 for production of oil, and optionally the oil recovery formulation, the oil immiscible formulation, water, and/or gas from the formation 205 via the first well 201. The first injection/production facility 217 may also include a separation unit 259 for separating oil, the oil recovery formulation, the oil immiscible formulation, water, and/or gas. The separation unit 259 may be comprised of a conventional liquid-gas separator for separating gas from the oil, oil recovery formulation, liquid oil immiscible formulation (if any), and water; a conventional hydrocarbon-water separator for separating the oil and oil recovery formulation from water and optionally from liquid oil immiscible formulation; a conventional distillation column for separating the oil recovery formulation—optionally in combination with C₃ to C₈, or C₃ to C₆, aliphatic and aromatic hydrocarbons derived from the formation—from the oil; and, optionally a separator for separating liquid oil immiscible formulation from water. The separation unit 259 may be fluidly operatively coupled to: the liquid storage tank 237 by conduit 261 for storage of produced oil in the liquid storage tank; the gas storage tank 241 by conduit 265 for storage of produced gas in the gas storage tank; and the water tank 247 by conduit 267 for storage of produced water in the water tank. Separated oil immiscible formulation, if any, may be provided from the separation unit 259 of the first injection/production facility 217 to the oil immiscible formulation storage facility 225 by conduit 268.

The separation unit 259 may be fluidly operatively coupled to the oil recovery formulation storage facility 215 by conduit 263 for storage of the produced oil recovery formulation in the oil recovery formulation storage facility 215. The separation unit 259 may be fluidly operatively coupled to either the injection mechanism 221 of the first injection/production facility 217 for injecting the oil recovery formulation into the formation 205 through the first well 201 or the injection mechanism 251 of the second injection/production facility 231 for injecting the oil recovery formulation into the formation through the second well 203 by conduits 242 and 244, respectively.

The first well 201 may be used for introducing the oil recovery formulation—and, optionally, subsequent to introduction of the oil recovery formulation via the first well, the oil immiscible formulation—into the formation 205 and the second well 203 may be used for producing oil from the formation for a first time period; then the second well 203 may be used for injecting the oil recovery formulation—and, optionally, subsequent to introduction of the oil recovery formulation via the second well, the oil immiscible formulation—into the formation 205 and the first well 201 may be used for producing oil from the formation for a second time period, where the first and second time periods comprise a cycle. Multiple cycles may be conducted which include alternating the first well 201 and the second well 203 between introducing the oil recovery formulation into the formation 205—and, optionally introducing the oil immiscible formulation into the formation subsequent to introduction of the oil recovery formulation—and producing oil from the formation, where one well is injecting and the other is producing for the first time period, and then they are switched for a second time period. A cycle may be from about 12 hours to about 1 year, or from about 3 days to about 6 months, or from about 5 days to about 3 months. In some embodiments, the oil recovery formulation may be introduced into the formation at the beginning of a cycle, and an oil immiscible formulation may be introduced at the end of the cycle. In some embodiments, the beginning of a cycle may be the first 10% to about 80% of a cycle, or the first 20% to about 60% of a cycle, the first 25% to about 40% of a cycle, and the end may be the remainder of the cycle.

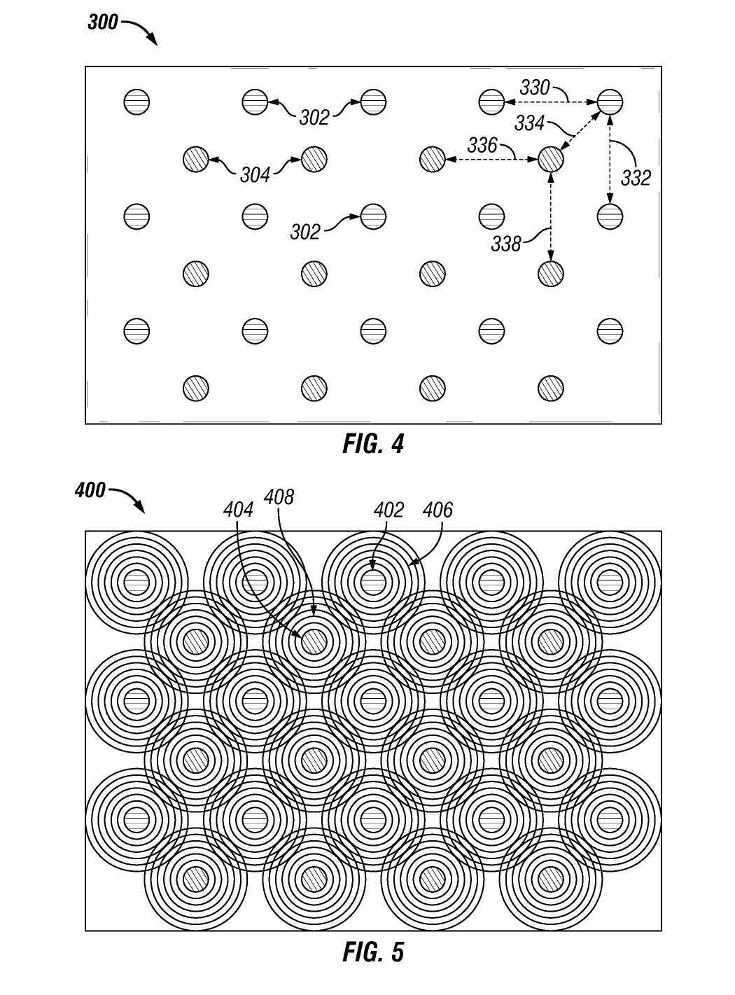

Referring now to FIG. 4, an array of wells 300 is illustrated. Array 300 includes a first well group 302 (denoted by horizontal lines) and a second well group 304 (denoted by diagonal lines). In some embodiments of the system and method of the present invention, the first well of the system and method described above may include multiple first wells depicted as the first well group 302 in the array 300, and the second well of the system and method described above may include multiple second wells depicted as the second well group 304 in the array 300.

Each well in the first well group 302 may be a horizontal distance 330 from an adjacent well in the first well group 302. The horizontal distance 330 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters. Each well in the first well group 302 may be a vertical distance 332 from an adjacent well in the first well group 302. The vertical distance 332 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the second well group 304 may be a horizontal distance 336 from an adjacent well in the second well group 304. The horizontal distance 336 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters. Each well in the second well group 304 may be a vertical distance 338 from an adjacent well in the second well group 304. The vertical distance 338 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the first well group 302 may be a distance 334 from the adjacent wells in the second well group 304. Each well in the second well group 304 may be a distance 334 from the adjacent wells in first well group 302. The distance 334 may be from about 5 to about 1000 meters, or from about 10 to about 500 meters, or from about 20 to about 250 meters, or from about 30 to about 200 meters, or from about 50 to about 150 meters, or from about 90 to about 120 meters, or about 100 meters.

Each well in the first well group 302 may be surrounded by four wells in the second well group 304. Each well in the second well group 304 may be surrounded by four wells in the first well group 302.

In some embodiments, the array of wells 300 may have from about 10 to about 1000 wells, for example from about 5 to about 500 wells in the first well group 302, and from about 5 to about 500 wells in the second well group 304.

In some embodiments, the array of wells 300 may be seen as a top view with first well group 302 and the second well group 304 being vertical wells spaced on a piece of land. In some embodiments, the array of wells 300 may be seen as a cross-sectional side view of the formation with the first well group 302 and the second well group 304 being horizontal wells spaced within the formation.

Referring now to FIG. 5, an array of wells 400 is illustrated. Array 400 includes a first well group 402 (denoted by horizontal lines) and a second well group 404 (denoted by diagonal lines). The array 400 may be an array of wells as described above with respect to array 300 in FIG. 4. In some embodiments of the system and method of the present invention, the first well of the system and method described above may include multiple first wells depicted as the first well group 402 in the array 400, and the second well of the system and method described above may include multiple second wells depicted as the second well group 404 in the array 400.

The oil recovery formulation may be injected into first well group 402 and oil may be recovered and produced from the second well group 404. As illustrated, the oil recovery formulation may have an injection profile 406, and oil may be produced from the second well group 404 having an oil recovery profile 408.

The oil recovery formulation may be injected into the second well group 404 and oil may be produced from the first well group 402. As illustrated, the oil recovery formulation may have an injection profile 408, and oil may be produced from the first well group 402 having an oil recovery profile 406.

The first well group 402 may be used for injecting the oil recovery formulation and the second well group 404 may be used for producing oil from the formation for a first time period; then second well group 404 may be used for injecting the oil recovery formulation and the first well group 402 may be used for producing oil from the formation for a second time period, where the first and second time periods comprise a cycle. In some embodiments, multiple cycles may be conducted which include alternating first and second well groups 402 and 404 between injecting the oil recovery formulation and producing oil from the formation, where one well group is injecting and the other is producing for a first time period, and then they are switched for a second time period.

To facilitate a better understanding of the present invention, the following examples of certain aspects of some embodiments are given. In no way should the following examples be read to limit, or define, the scope of the invention.

### Example 1

The quality of dimethyl sulfide as an oil recovery agent based on the miscibility of dimethyl sulfide with a crude oil relative to other compounds was evaluated. The miscibility of dimethyl sulfide, ethyl acetate, o-xylene, carbon disulfide, chloroform, dichloromethane, tetrahydrofuran, and pentane solvents with mined oil sands was measured by extracting the oil sands with the solvents at 10° C. and at 30° C. to determine the fraction of hydrocarbons extracted from the oil sands by the solvents. The bitumen content of the mined oil sands was measured at 11 wt. % as an average of bitumen extraction yield values for solvents known to effectively extract substantially all of bitumen from oil sands—in particular chloroform, dichloromethane, o-xylene, tetrahydrofuran, and carbon disulfide. One oil sands sample per solvent per extraction temperature was prepared for extraction, where the solvents used for extraction of the oil sands samples were dimethyl sulfide, ethyl acetate, o-xylene, carbon disulfide, chloroform, dichloromethane, tetrahydrofuran, and pentane. Each oil sands sample was weighed and placed in a cellulose extraction thimble that was placed on a porous polyethylene support disk in a jacketed glass cylinder with a drip rate control valve. Each oil sands sample was then extracted with a selected solvent at a selected temperature (10° C. or 30° C.) in a cyclic contact and drain experiment, where the contact time ranged from 15 to 60 minutes. Fresh contacting solvent was applied and the cyclic extraction repeated until the fluid drained from the apparatus became pale brown in color.

The extracted fluids were stripped of solvent using a rotary evaporator and thereafter vacuum dried to remove residual solvent. The recovered bitumen samples all had residual solvent present in the range of from 3 wt. % to 7 wt. %. The residual solids and extraction thimble were air dried, weighed, and then vacuum dried. Essentially no weight loss was observed upon vacuum drying the residual solids, indicating that the solids did not retain either extraction solvent or easily mobilized water. Collectively, the weight of the solid or sample and thimble recovered after extraction plus the quantity of bitumen recovered after extraction divided by the weight of the initial oil sands sample plus the thimble provide the mass closure for the extractions. The calculated percent mass closure of the samples was slightly high because the recovered bitumen values were not corrected for the 3 wt. % to 7 wt. % residual solvent. The extraction experiment results are summarized in Table 1.

TABLE 1
Summary of Extraction Experiments of Bituminous Oil Sands with Various Fluids

| | | Input | Output | | | Experimental |
|---|---|---|---|---|---|---|
| | | Solids | Solids | Weight | Recovered | Weight |
| Extraction Fluid | Temperature, C. | weight, g | weight, g | Change, g | Bitumen, g | Closure, % |
| Carbon Disulfide | 30 | 151.1 | 134.74 | 16.4 | 16.43 | 100.0 |
| Carbon Disulfide | 10 | 151.4 | 134.62 | 16.8 | 16.62 | 99.9 |
| Chloroform | 30 | 153.7 | 134.3 | 19.4 | 18.62 | 99.5 |
| Chloroform | 10 | 156.2 | 137.5 | 18.7 | 17.85 | 99.5 |
| Dichloromethane | 30 | 155.8 | 138.18 | 17.7 | 16.30 | 99.1 |
| Dichloromethane | 10 | 155.2 | 136.33 | 18.9 | 17.66 | 99.2 |
| o-Xylene | 30 | 156.1 | 136.58 | 19.5 | 17.37 | 98.6 |
| o-Xylene | 10 | 154.0 | 136.66 | 17.3 | 17.36 | 100.0 |
| Tetrahydrofuran | 30 | 154.7 | 136.73 | 18.0 | 17.67 | 99.8 |
| Tetrahydrofuran | 10 | 154.7 | 136.98 | 17.7 | 16.72 | 99.4 |
| Ethyl Acetate | 30 | 153.5 | 135.81 | 17.7 | 11.46 | 96.0 |
| Ethyl Acetate | 10 | 155.7 | 144.51 | 11.2 | 10.32 | 99.4 |
| Pentane | 30 | 154.0 | 139.11 | 14.9 | 13.49 | 99.1 |
| Pentane | 10 | 152.7 | 138.65 | 14.1 | 13.03 | 99.3 |
| Dimethyl Sulfide | 30 | 154.2 | 137.52 | 16.7 | 16.29 | 99.7 |
| Dimethyl Sulfide | 10 | 151.7 | 134.77 | 16.9 | 16.55 | 99.7 |

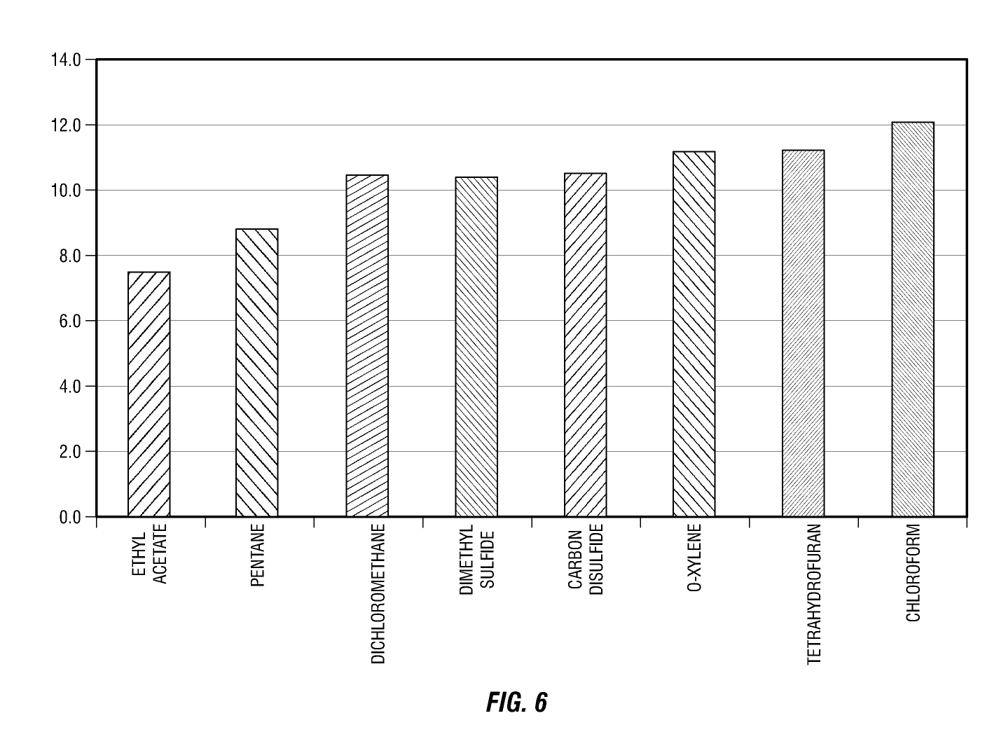

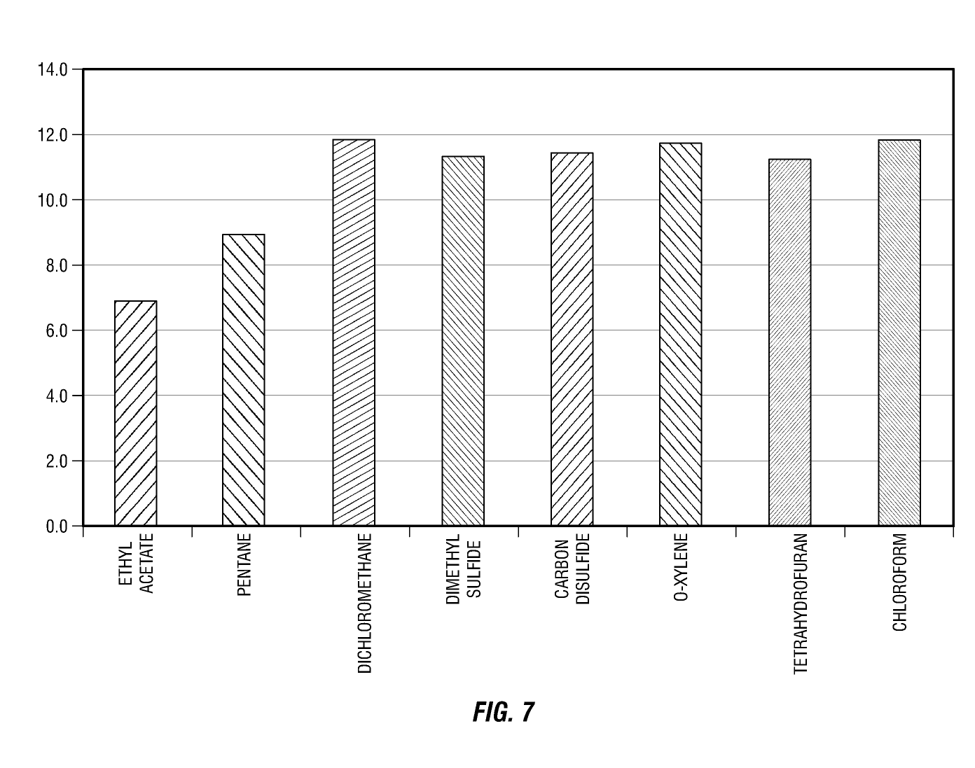

FIG. 6 provides a graph plotting the weight percent yield of extracted bitumen as a function of the extraction fluid at 30° C. applied with a correction factor for residual extraction fluid in the recovered bitumen, and FIG. 7 provides a similar graph for extraction at 10° C. without a correction factor. FIGS. 6 and 7 and Table 1 show that dimethyl sulfide is comparable for recovering bitumen from an oil sand material with the best known fluids for recovering bitumen from an oil sand material—o-xylene, chloroform, carbon disulfide, dichloromethane, and tetrahydrofuran—and is significantly better than pentane and ethyl acetate.

The bitumen samples extracted at 30° C. from each oil sands sample were evaluated by SARA analysis to determine the saturates, aromatics, resins, and asphaltenes composition of the bitumen samples extracted by each solvent. The results are shown in Table 2.

TABLE 2
SARA Analysis of Extracted Bitumen Samples as a
Function of Extraction Fluid

| | Oil Composition Normalized Weight Percent | | | |
|---|---|---|---|---|
| Extraction Fluid | Saturates | Aromatics | Resins | Asphaltenes |
| Ethyl Acetate | 21.30 | 53.72 | 22.92 | 2.05 |
| Pentane | 22.74 | 54.16 | 22.74 | 0.36 |
| Dichloromethane | 15.79 | 44.77 | 24.98 | 14.45 |
| Dimethyl Sulfide | 15.49 | 47.07 | 24.25 | 13.19 |
| Carbon Disulfide | 18.77 | 41.89 | 25.49 | 13.85 |
| o-Xylene | 17.37 | 46.39 | 22.28 | 13.96 |
| Tetrahydrofuran | 16.11 | 45.24 | 24.38 | 14.27 |
| Chloroform | 15.64 | 43.56 | 25.94 | 14.86 |

The SARA analysis showed that pentane and ethyl acetate were much less effective for extraction of asphaltenes from oil sands than are the known highly effective bitumen extraction fluids dichloromethane, carbon disulfide, o-xylene, tetrahydrofuran, and chloroform. The SARA analysis also showed that dimethyl sulfide has excellent miscibility properties for even the most difficult hydrocarbons—asphaltenes.

The data showed that dimethyl sulfide is generally as good as the recognized very good bitumen extraction fluids for recovery of bitumen from oil sands, and is highly compatible with saturates, aromatics, resins, and asphaltenes.

### Example 2

The quality of dimethyl sulfide as an oil recovery agent based on the crude oil viscosity lowering properties of dimethyl sulfide was evalulated. Three crude oils having widely disparate viscosity characteristics—an African Waxy crude, a Middle Eastern asphaltic crude, and a Canadian asphaltic crude—were blended with dimethyl sulfide. Some properties of the three crudes are provided in Table 3.

TABLE 3
Crude Oil Properties

| | | Middle | |
|---|---|---|---|
| | African | Eastern | Canadian |
| | Waxy | Asphaltic | Asphaltic |
| | crude | crude | Crude |
| Hydrogen (wt. %) | 13.21 | 11.62 | 10.1 |
| Carbon (wt. %) | 86.46 | 86.55 | 82 |
| Oxygen (wt. %) | na | na | 0.62 |
| Nitrogen (wt. %) | 0.166 | 0.184 | 0.37 |
| Sulfur (wt. %) | 0.124 | 1.61 | 6.69 |
| Nickel (ppm wt.) | 32 | 14.2 | 70 |
| Vanadium (ppm wt.) | 1 | 11.2 | 205 |
| microcarbon residue (wt. %) | na | 8.50 | 12.5 |
| C₅ Asphaltenes (wt. %) | <0.1 | na | 16.2 |
| C₇ Asphaltenes (wt. %) | <0.1 | na | 10.9 |
| Density (g/ml) (15.6° C.) | 0.88 | 0.9509 | 1.01 |
| API Gravity (15.6° C.) | 28.1 | 17.3 | 8.5 |
| Water (Karl Fisher Titration) (wt. %) | 1.65 | <0.1 | <0.1 |
| TAN-E (ASTM D664) (mg KOH/g) | 1.34 | 4.5 | 3.91 |
| Volatiles Removed by Topping, wt. % | 21.6 | 0 | 0 |
| Saturates in Topped Fluid, wt. % | 60.4 | 41.7 | 12.7 |
| Aromatics in Topped Fluid, wt. % | 31.0 | 40.5 | 57.1 |
| Resin in Topped Fluid, wt. % | 8.5 | 14.5 | 17.1 |
| Asphaltenes in Topped Fluid, wt. % | 0.1 | 3.4 | 13.1 |

Boiling Range Distribution

| | | | |
|---|---|---|---|
| Initial Boiling Point-204° C. (wt. %) | 8.5 | 3.0 | 0 |
| 204° C. (400° F.)-260° C. (wt. %) | 9.5 | 5.8 | 1.0 |
| 260° C. (500° F.)-343° C. (wt. %) | 16.0 | 14.0 | 14.0 |
| 343° C. (650° F.)-538° C. (wt. %) | 39.5 | 42.9 | 38.0 |
| >538° C. (wt. %) | 26.5 | 34.3 | 47.0 |

A control sample of each crude was prepared containing no dimethyl sulfide, and samples of each crude were prepared and blended with dimethyl sulfide to prepare crude samples containing increasing concentrations of dimethyl sulfide. Each sample of each of the crudes was heated to 60° C. to dissolve any waxes therein and to permit weighing of a homogeneous liquid, weighed, allowed to cool overnight, and then blended with a selected quantity of dimethyl sulfide. The samples of the crude/dimethyl sulfide blend were then heated to 60° C. and mixed to ensure homogeneous blending of the dimethyl sulfide in the samples. Absolute (dynamic) viscosity measurements of each of the samples were taken using rheometer and closed cup sensor assembly. Viscosity measurements of each of the samples of the West African waxy crude and the Middle Eastern asphaltic crude were taken at 20° C., 40° C., 60° C., 80° C., and then again at 20° C. after cooling from 80° C., where the second measurement at 20° C. is taken to measure the viscosity without the presence of waxes since wax formation occurs slowly enough to permit viscosity measurement at 20° C. without the presence of wax. Viscosity measurements of each of the samples of the Canadian asphaltic crude were taken at 5° C., 10° C., 20° C., 40° C., 60° C., 80° C. The measured viscosities for each of the crudes are shown in Tables 4, 5, and 6 below.

TABLE 4
Viscosity (mPa s) of West African Waxy Crude vs. Temperature
at Various levels of Dimethyl Sulfide Diluent

| DMS, wt. % | 20° C. | 40° C. | 60° C. | 80° C. | 20° C. |
|---|---|---|---|---|---|
| 0.00 | 128.8 | 34.94 | 15.84 | 9.59 | 114.4 |
| 1.21 | 125.8 | 30.94 | 14.66 | 8.92 | 100.1 |
| 2.48 | 122.3 | 30.53 | 13.66 | 8.44 | 89.23 |
| 5.03 | 78.37 | 20.24 | 10.45 | 6.55 | 55.21 |
| 7.60 | 60.92 | 17.08 | 9.29 | 6.09 | 40.89 |
| 9.95 | 44.70 | 13.03 | 7.58 | 5.04 | 30.61 |
| 15.13 | 23.96 | 8.32 | 4.97 | 3.38 | 17.64 |
| 19.30 | 15.26 | 6.25 | 4.05 | 2.92 | 12.06 |

TABLE 5
Viscosity (mPa s) of Middle Eastern Asphaltic Crude vs. Temperature
at Various levels of Dimethyl Sulfide Diluent

| DMS, wt. % | 20° C. | 40° C. | 60° C. | 80° C. | 20° C. |
|---|---|---|---|---|---|
| 0.00 | 2936.3 | 502.6 | 143.6 | 56.6 | 2922.7 |
| 1.3 | 1733.8 | 334.5 | 106.7 | 44.6 | 1624.8 |
| 2.6 | 1026.6 | 219.9 | 76.5 | 34.3 | 881.1 |
| 5.3 | 496.5 | 134.2 | 52.2 | 25.5 | 503.5 |
| 7.6 | 288.0 | 89.4 | 37.4 | 19.3 | 290.0 |
| 10.1 | 150.0 | 52.4 | 24.5 | 13.5 | 150.5 |
| 15.2 | 59.4 | 25.2 | 13.6 | 8.2 | 60.7 |
| 20.1 | 29.9 | 14.8 | 8.7 | 5.7 | 31.0 |

TABLE 6
Viscosity (mPa s) of Topped Canadian Asphaltic Crude vs.
Temperature at Various levels of Dimethyl Sulfide Diluent

| DMS, wt. % | 5° C. | 10° C. | 20° C. | 40° C. | 60° C. | 80° C. |
|---|---|---|---|---|---|---|
| 0.00 | | | 579804 | 28340 | 3403 | 732 |
| 1.43 | | | 212525 | 14721 | 2209 | 538 |
| 2.07 | | | 134880 | 10523 | 1747 | 427 |
| 4.87 | | | 28720 | 3235 | 985 | 328 |
| 8.01 | | | 5799 | 982 | 275 | 106 |
| 9.80 | | | 2760 | 571 | 173 | 73 |
| 14.81 | 1794 | 1155 | 548 | 159 | 64 | 32 |
| 19.78 | | | 188 | 69 | 33 | 19 |
| 29.88 | 113 | 81 | 51 | 22 | 13 | 8 |
| 39.61 | 23 | 20 | 14 | 8 | 6 | 4 |

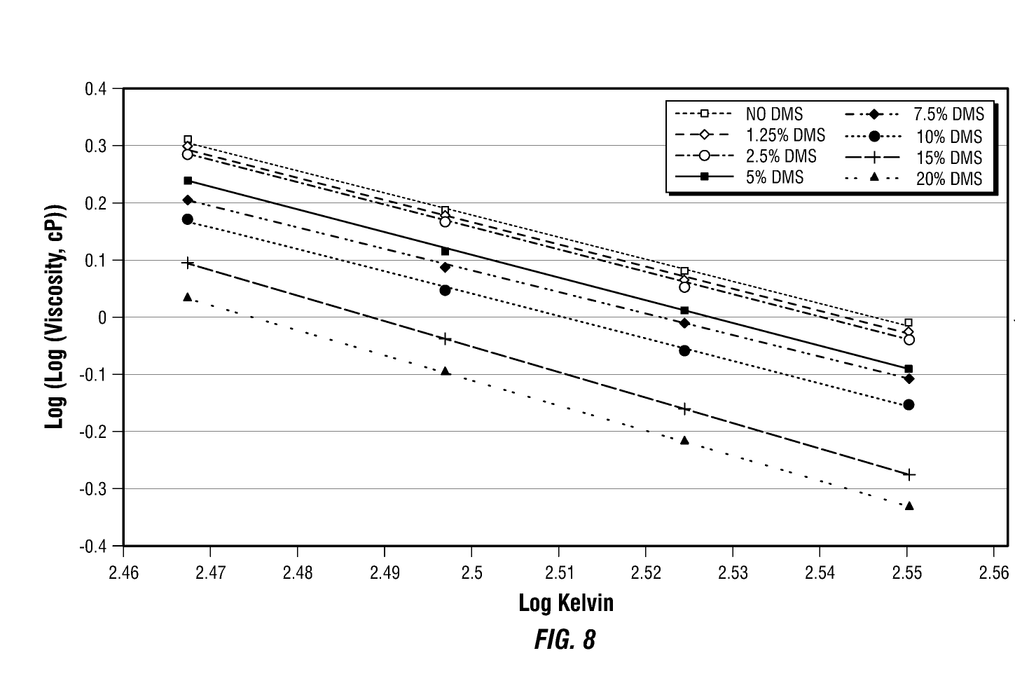

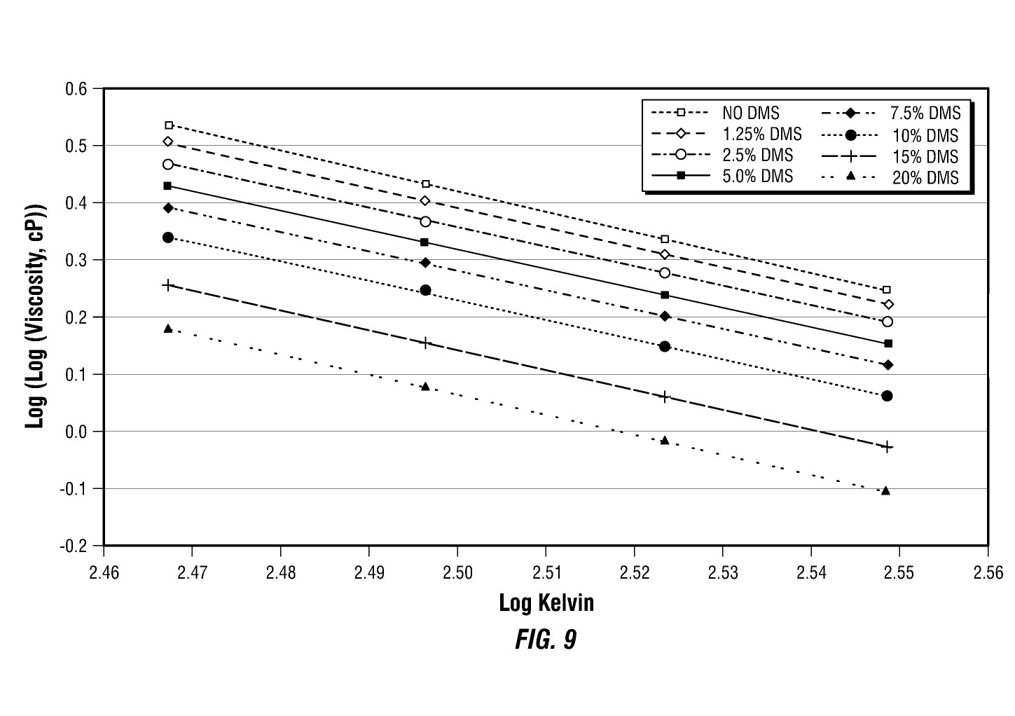

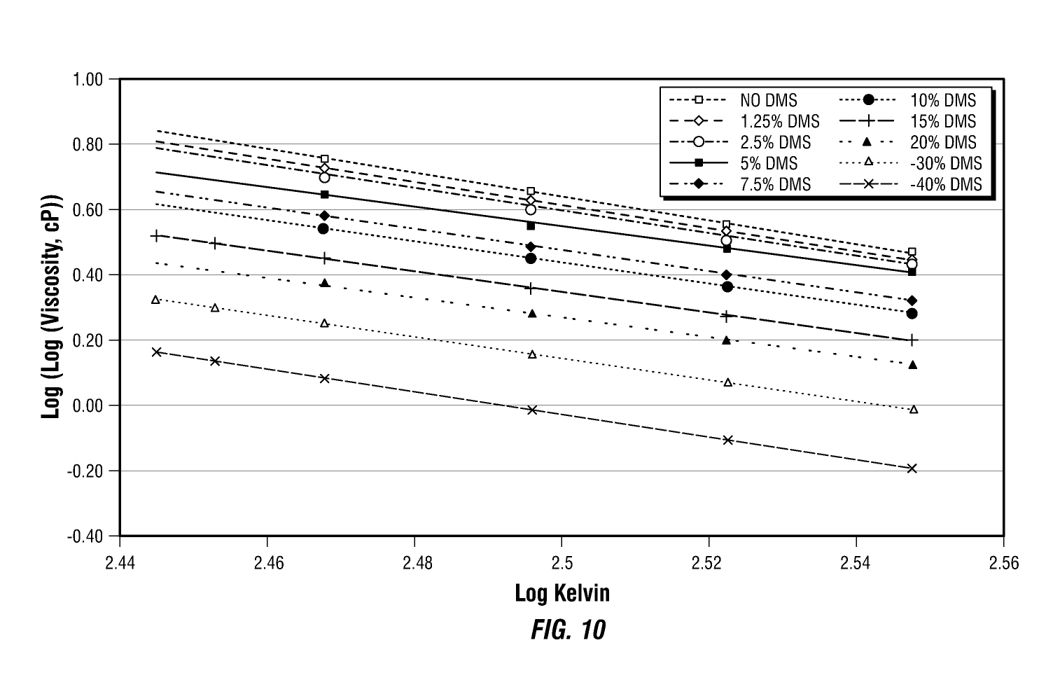

FIGS. 8, 9, and 10 show plots of Log [Log(Viscosity)] v. Log [Temperature ° K] derived from the measured viscosities in Tables 4, 5, and 6, respectively, illustrating the effect of increasing concentrations of dimethyl sulfide in lowering the viscosity of the crude samples.

The measured viscosities and the plots show that dimethyl sulfide is effective for significantly lowering the viscosity of a crude oil over a wide range of initial crude oil viscosities.

### Example 3

Incremental recovery of oil from a formation core using an oil recovery formulation consisting of dimethyl sulfide following oil recovery from the core by waterflooding was measured to evaluate the effectiveness of DMS as a tertiary oil recovery agent.

Two 5.02 cm long Berea sandstone cores with a core diameter of 3.78 cm and a permeability between 925 and 1325 mD were saturated with a brine having a composition as set forth in Table 7.

TABLE 7
Brine Composition

| | Chemical component | | | | | |
|---|---|---|---|---|---|---|
| | CaCl₂ | MgCl₂ | KCl | NaCl | Na₂SO₄ | NaHCO₃ |
| Concentration | 0.386 | 0.523 | 1.478 | 28.311 | 0.072 | 0.181 |
| (kppm) | | | | | | |

After saturation of the cores with brine, the brine was displaced by a Middle Eastern Asphaltic crude oil having the characteristics as set forth above in Table 3 to saturate the cores with oil.

Oil was recovered from each oil saturated core by the addition of brine to the core under pressure and by subsequent addition of DMS to the core under pressure. Each core was treated as follows to determine the amount of oil recovered from the core by addition of brine followed by addition of DMS. Oil was initially displaced from the core by addition of brine to the core under pressure. A confining pressure of 1 MPa was applied to the core during addition of the brine, and the flow rate of brine to the core was set at 0.05 ml/min. The core was maintained at a temperature of 50° C. during displacement of oil from the core with brine. Oil was produced and collected from the core during the displacement of oil from the core with brine until no further oil production was observed (24 hours). After no further oil was displaced from the core by the brine, oil was displaced from the core by addition of DMS to the core under pressure. DMS was added to the core at a flow rate of 0.05 ml/min for a period of 32 hours for the first core and for a period of 15 hours for the second core. Oil displaced from the core during the addition of DMS to the core was collected separately from the oil displaced by the addition of brine to the core.

The oil samples collected from each core by brine displacement and by DMS displacement were isolated from water by extraction with dichloromethane, and the separated organic layer was dried over sodium sulfate. After evaporation of volatiles from the separated, dried organic layer of each oil sample, the amount of oil displaced by brine addition to a core and the amount of oil displaced by DMS addition to the core were weighed. Volatiles were also evaporated from a sample of the Middle Eastern asphaltic oil to be able to correct for loss of light-end compounds during evaporation. Table 8 shows the amount of oil produced from each core by brine displacement followed by DMS displacement.

TABLE 8

| | | Oil produced | | |
|---|---|---|---|---|
| | | Brine | | Oil produced |
| | Oil produced | displacement | Oil produced | DMS |
| | Brine | (of % oil | DMS | displacement |
| | displacement | initially | displacement | (of % oil initially |
| | (ml) | in core) | (ml) | in core) |
| Core 1 | 4.9 | 45 | 3.5 | 32 |
| Core 2 | 5.0 | 45 | 3.3 | 30 |

As shown in Table 8, DMS is quite effective for recovering an incremental quantity of oil from a formation core after recovery of oil from the core by waterflooding with a brine solution—recovering approximately 60% of the oil remaining in the core after the waterflood.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. While systems and methods are described in terms of “comprising,” “containing,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from a to b,” or, equivalently, “from a-b”) disclosed herein is to be understood to set forth every number and range encompassed within the broader range of values. Whenever a numerical range having a specific lower limit only, a specific upper limit only, or a specific upper limit and a specific lower limit is disclosed, the range also includes any numerical value “about” the specified lower limit and/or the specified upper limit. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces.

What is claimed is:

1. A method for producing oil from a hydrocarbon-bearing formation comprised of hydrocarbons and formation water, comprising:
providing an oil recovery formulation comprising at least 75 mol % of dimethyl sulfide, and between 1 mol % and 18 mol % of dimethyl ether, wherein the amount of dimethyl ether in the oil recovery formulation is selected relative to the solubility of the dimethyl ether in in the formation water;
introducing the oil recovery formulation into a hydrocarbon-bearing formation;
contacting the oil recovery formulation with oil in the formation; and
producing oil from the formation after contact of the oil recovery formulation with oil in the formation.

2. The method of claim 1 wherein the hydrocarbon-bearing formation is a subterranean formation.

3. The method of claim 2 wherein the subterranean formation is comprised of a material selected from the group consisting of a porous mineral matrix, a porous rock matrix, and a combination of a porous mineral matrix and a porous rock matrix.

4. The method of claim 3 wherein the porous mineral or rock matrix is a consolidated matrix comprising sandstone, limestone, or dolomite.

5. The method of claim 2 wherein the oil recovery formulation is introduced into the formation by injection via a well extending into the formation.

6. The method of claim 5 wherein the oil is produced from the formation via the well.

7. The method of claim 5 wherein the well through which the oil recovery formulation is introduced into the formation is a first well, and oil is produced from the formation via a second well extending into the formation.

8. The method of claim 1 wherein the oil recovery formulation contains dimethyl ether, on a mole percent basis, of from 80-100% of the maximum amount of dimethyl ether that is soluble in the formation water in a single phase.

9. The method of claim 1 wherein the oil recovery formulation has a dynamic viscosity of at most 0.35 mPa s (0.3 cP) at 25° C.

10. The method of claim 1 wherein the oil recovery formulation has a density of at most 0.9 g/cm³.

11. The method of claim 1 wherein the oil recovery formulation has an aquatic toxicity of LC₅₀>200 mg/l at 96 hours.

12. The method of claim 1 wherein the oil recovery formulation is produced from the formation with oil.

13. The method of claim 1 further comprising the step of introducing an oil immiscible formulation into the oil-bearing formation subsequent to introduction of the oil recovery formulation into the formation.
